(19) United States
(12) Patent Application Publication
(10) Pub. No.: US 2025/0208396 A1
(43) Pub. Date: Jun. 26, 2025

(54) Microscope with fast quasi-confocal detection

(71) Applicant: Carl Zeiss Microscopy GmbH, JENA (DE)

(72) Inventors: Matthias WALD, JENA (DE); Tiemo ANHUT, JENA (DE); Daniel SCHWEDT, JENA (DE)

(73) Assignee: Carl Zeiss Microscopy GmbH, JENA (DE)

(21) Appl. No.: 18/986,473

(22) Filed: Dec. 18, 2024

(30) Foreign Application Priority Data
Dec. 19, 2023 (DE) 10 2023 005 252.3

(51) Int. Cl. G02B 21/00; G01N 21/64

(52) U.S. Cl. CPC G02B 21/0032; G02B 21/0048; G02B 21/0076; G02B 21/008; G01N 21/6428; G01N 2021/6439; G01N 21/6458

(57) ABSTRACT

A microscope with fast quasi-confocal detection has a main beam splitter and an adjustable beam deflection unit for moving an illumination light through a sample space. The beam deflection unit is optically arranged between a light source and a main beam splitter such that the sample light away from the beam deflection unit passes to a sensor, wherein both the illumination light and the sample light pass through the same intermediate image.

### RELATED APPLICATIONS

The present application is a U.S. National Stage application which claims priority benefit of German Application No. DE 10 2023 005 252.3 filed on Dec. 19, 2023, the contents of which are incorporated by reference in their entirety.

### BACKGROUND OF THE INVENTION

The invention relates to a microscope having an illumination beam path, a detection beam path and a main beam splitter, wherein the detection beam path comprises a sample space, a microscope objective, a tube lens, an intermediate image created by the tube lens and a two-dimensionally spatially resolving optoelectronic sensor having a detection optical unit for imaging the intermediate image on the sensor and wherein the illumination beam path comprises a light source and an adjustable beam deflection unit for moving (“scanning”, “raster scanning”) the illumination light through the sample space, wherein the illumination beam path and the detection beam path are optically coupled to form a common beam path by means of the main beam splitter such that illumination light from the light source passes into the sample space through the microscope objective via the main beam splitter and sample light from the sample space passes through the microscope objective via the main beam splitter to the sensor.

Confocal fluorescence imaging provides high-contrast, high-resolution images of biological samples. As in DE 197 02 753 A1, the sample is scanned point by point using laser illumination and the created fluorescence is detected confocally through a pinhole. This stop stops down out-of-focus light very effectively, resulting in the high contrast. However, the comparatively long acquisition time on account of point-by-point scanning is disadvantageous. This inevitably also leads to a high phototoxic sample load due to the excitation light.

The disadvantages of point-by-point imaging can be reduced by parallelization. Examples of this are confocal microscopes having a Nipkow disc and light sheet microscopes, the latter requiring an additional illumination optical unit. As an alternative, parallelization can be achieved by means of a linear illumination as in EP 1 617 258 A1. In order to achieve confocality at least in one dimension (transversely to the line), linear detection using a slit- type stop is also necessary here.

Instead of a mechanical slit-type stop, a sensor with an electronic slit-type stop, in particular in the form of a rolling shutter, can be used, with which the beam deflection unit is synchronized. Such electronic slit-type stops are known for example from “Virtual slit scanning microscopy” by R. Fiolka et al. in “Histochemistry and Cell Biology”, volume 128 (6), 2007 (DOI 10.1007/s00418-007-0342-2) and from “Inexpensive and Flexible Slit-Scanning Confocal Imaging Using a Rolling Electronic Aperture” by M. S. Muller et al. in “Microscopy Instrument and Software Developments (FWW)” at the “Frontiers in Optics 2008” conference (DOI 10.1364/FIO.2008.FWW2). The sample light passes to the sensor away from the beam deflection unit; this can be referred to as non-descanned detection.

For further parallelization, as in DE 10 2021 134 427 A1, the sample light can be divided by means of beam splitters such that different sample planes or different spectral ranges are imaged simultaneously on disjoint regions of the sensor. This reduces the acquisition time by a corresponding integer factor. However, this arrangement has the disadvantage of occupying two ports of the microscope, one for the illumination beam path and one for the detection beam path. This limits the flexibility of the microscope. Moreover, two separate modules are required for illumination and detection, and this is costly.

A further disadvantage thereof is that at least one of the image fields is displaced relative to the optical axis of detection. The linear illumination, on the other hand, is centered as a central region of the sample is excited on the object side. This breaking of symmetry between excitation and detection leads to a tilt of the image of the focus volume on the sensor. In the event of large fields, the image can extend beyond the region of a slit-type stop, in particular of a “rolling shutter”. Line-confocal detection is no longer possible in that case, as it is inevitably implemented in a manner aligned strictly along a pixel line of the sensor.

### OBJECTS OF THE INVENTION

The problem addressed by the invention is that of improving a microscope of the type mentioned at the outset such that a more flexible, less complicated use is rendered possible. In addition, it should be possible to record larger fields in special embodiments.

The problem is solved by a microscope having the features specified in claim 1.

Advantageous configurations of the invention are specified in the dependent claims.

### BREIF DESCRIPTION OF THE INVENTION

According to the invention, provision is made for the beam deflection unit to be optically arranged between the light source and the main beam splitter such that the sample light away from the beam deflection unit passes to the sensor, and for both the illumination light traveling to the microscope objective and the sample light traveling to the sensor to pass through the same intermediate image created by the tube lens. The sample light passes to the sensor away from the beam deflection unit; this can be referred to as non-descanned detection.

Advantageously, only a single port of the microscope is occupied as a result of sharing the same intermediate image for illumination and detection. Possible further ports are available for other uses, and so the microscope-while retaining a short acquisition time-has greater flexibility than known microscopes. In particular, fast quasi-confocal microscopy can be combined in a multimodal manner with other methods that require their own port. Illumination and detection can advantageously be integrated into a single module, reducing fabrication and installation outlay and enabling a more compact and stable design. In comparison with light sheet microscopes, moreover, this only requires a single illumination optical unit in the form of the microscope objective.

### EMBODIMENTS OF THE INVENTION

In an advantageous embodiment, an optical system, preferably a scan lens, for creating a pupil plane which is conjugate to a pupil (back focal plane) of the microscope objective and located on or near the beam deflection unit is contained in the common beam path, optically between the intermediate image and the main beam splitter. As a result, on the one hand, the main beam splitter is arranged in collimated light, and so possible contaminations have only a small influence on its transmission quality. On the other hand, this allows compact coupling of illumination and detection beam paths without the need—as in the prior art—for additional collimation. In particular, this eliminates the need for an additional relay optical unit.

Particularly advantageously, the conjugate pupil plane can arise due to reflection off the main beam splitter in this embodiment, and so the beam deflection unit is located in or near the reflected conjugate pupil plane, in particular with transmission through the conjugate pupil plane into the detection beam path in the vicinity of a secondary beam splitter, and so the secondary beam splitter is located in or near the passed conjugate pupil plane. In this way, no additional relay optical unit is required in the detection beam path. The transmission into the detection beam path leads (in comparison with an arrangement in reflection) to improved extinction of the excitation light, and so an improved contrast of the measurement signal to the excitation signal is attained at the detector. In particular, the secondary beam splitter can be arranged in collimated light as a result, and so possible contaminations have only a small influence on its transmission quality.

Preferably, the detection optical unit is arranged in such a way that its optical axis is tilted by a (plane) non-zero angle relative to an optical axis of the microscope objective (optionally deflected by at least one reflection), and so an image of the sample space on the sensor is offset away from the optical axis by an offset length, for example by one quarter of the sensor width, and the beam deflection unit (in particular its scanning axis of rotation, about which an adjustable deflection mirror is rotatable) is tilted by a second (plane) non-zero angle about an axis perpendicular to its scanning axis of rotation (within a plane spanned by the sensor lines and the optical axis of the microscope objective) such that a first aberration resulting from the tilt of the detection optical unit, in particular a distortion, and a second aberration resulting from the tilt of the beam deflection unit, in particular a distortion as well, compensate each other at least in part (such that there is better correspondence between the illumination focus volume and the detection focus volume, and in particular the illumination focus volume is imaged on the sensor in a manner parallel to the sensor lines over a larger sample region). This can reduce the aberrations such that larger fields can be acquired. In particular, the first tilt angle and the second tilt angle can be of the same size.

To minimize aberrations, a vertical arrangement of the optical axis of the detection optical unit with respect to a surface of the sensor might be provided. At the main beam splitter, the angle of incidence of the illumination light that comes from the beam deflection unit is configured such that the optical axis of the illumination beam path and that of the microscope objective coincide in the common (coupled) beam path (between the main beam splitter and the microscope objective). Typically, the angle of incidence is 45°—as in conventional reflected light scanning microscopes—despite the tilt of the beam deflection unit. To this end, a preferably adjustable deflection mirror is expediently arranged between the light source and the beam deflection unit. Small angles of incidence of less than 15° or less than 10° can be provided as an alternative to an angle of incidence of 45° at the main beam splitter.

Without a beam deflection unit tilt, the detection optical unit tilt would result in the image representation of the illumination focus volume on the sensor extending according to

$$y ( x ) = {y}_{0} \cdot ( 1 + \frac{x \cdot Δ x}{{f}^{2}} ) - i . e .$$

obliquely with a y-position dependence—in a manner dependent on position x (x is the direction along the sensor lines and parallel to the line-confocal slit-type stop) and dependent on the sensor-side focal length f of the detection optical unit (see FIG. 3a), where y is the direction transverse to the sensor lines and transverse to the line-confocal slit-type stop, and y₀ is the distance from the optical axis along this direction and Δx is the offset length resulting from the tilt. This aberration (inclination, distortion) is equivalent to an aberration that arises when a scan mirror is used away from the optical axis, i.e. when the scanning axis of rotation of the scan mirror is not perpendicular to the plane spanned by the normal vector of the scan mirror and the propagation vector (mean k-vector) of the incident illumination light. In more pictorial terms, the tilted beam deflection unit causes the illumination focus volume to lie obliquely in the sample space. On account of the tilted detection optical unit, the sensor is directed at the sample space with the same y-position-dependent tilt, and so the illumination line is parallel to its pixel lines in its frame of reference. According to the invention, the scanning axis of rotation of the beam deflection unit is preferably arranged parallel to the plane spanned by the normal vector of the scan mirror and the propagation vector (mean k-vector) of the incident illumination light in order to attain maximum compensation of the aberration. Then, the angle of incidence of the illumination light at the scan mirror in its zero position (neutral position without an artificial force acting on the scan mirror) is equal to the tilt angle of the detection optical unit.

The (in particular identical) tilt angles of the detection optical unit and the beam deflection unit are preferably approximately arctan(Δx/f), where Δx is the offset length and f is the (sensor-side) focal length of the detection optical unit. The aberrations can be largely compensated by this tilt angle. In order to compensate for residual aberrations of the detection optical unit, the tilt angle can also deviate therefrom by a specified measure. For example, line warping can be mediated by a distortion of the detection optical unit such that it has only a minimal effect on the sensor.

In particular, the beam deflection unit can be rotated around its scanning axis of rotation—in addition to tilt—so that the illumination light passes to the beam deflection unit without intersecting an optical axis of the common beam path. In this way, the illumination light can be guided spatially around the main beam splitter to the beam deflection unit by guiding the illumination light past the main beam splitter in a plane truly parallel to one spanned by the optical axis of the microscope objective and the longitudinal direction of the pixel lines of the sensor (i.e. outside this plane), enabling a compact arrangement of the illumination beam path and the detection beam path, especially in a common module.

The beam deflection unit can deflect the illumination light one-dimensionally or two-dimensionally. In the two-dimensional case, this preferably relates to point-by-point scanning of the sample with a punctiform illumination spot or illumination volume.

Embodiments with linear illumination and detection are preferred in comparison; in these, the illumination beam path advantageously comprises a beam shaper (for example, a cylindrical lens) for creating a linear distribution of illumination light and the sensor comprises a linear stop, wherein the stop is arranged confocally with the intermediate image and can be an electronic stop in particular, especially in the form of a “rolling shutter”. The linear illumination allows for a shorter acquisition time. In particular, an adjustment of the beam deflection unit can be synchronized with a dynamic position (movement) of the stop, in particular by way of a control unit that is electrically connected to the sensor and the beam deflection unit. This allows for a minimization of the acquisition time. To this end, the sensor can preferably have a light sheet readout mode (as referred to by Hamamatsu) and have a port at which information about the position and/or movement of the stop is present, in particular a signal indicating a start of an image (“frame”) on the sensor. Commercially, sensors with such a mode and a corresponding port are available from Hamamatsu: https://www.hamamatsu.com/eu/en/product/cameras/cmos-cameras/lightshect-readout-mode.html. The port is referred to by Hamamatsu as “external trigger output”.

Advantageously, the detection beam path between the main beam splitter and the detection optical unit can comprise a secondary beam splitter and at least one reflector, in particular in the form of a prism, wherein the secondary beam splitter divides the sample light into two components and guides the latter to disjoint regions of the sensor or to a respective sensor such that two disjoint images of the sample space arise, in particular with identical offset lengths for both images (and identical angles between the optical axes of the images and the optical axis of the detection optical unit, in particular with point symmetry between the components with respect to the optical axis of the detection optical unit), wherein only one of the components passes to the relevant sensor via the reflector. Thus, two images can be acquired simultaneously in order to shorten the acquisition duration, in particular in different spectral ranges by forming the secondary beam splitter to split colors, in particular in the form of a dichroic splitter. With identical offset lengths (and identical angles to the optical axis of the detection optical unit, in particular with point symmetry with respect to the optical axis of the detection optical unit), the aberrations that result from the tilt of the detection optical unit are maximally compensated in both images.

In such an embodiment, the illumination beam path can preferably comprise a second light source having a different emission wavelength to the first light source and/or the secondary beam splitter can be a color splitter, in particular a high pass filter or a low pass filter. In this way, two spectral ranges, in particular of two different fluorescent dyes, associated with the emission wavelengths can be acquired simultaneously and with few image errors in a short time. The first and the second light source can be the same light source, for example in the form of a multiline laser or a broadband light source, in particular a white light source.

In an advantageous method for scanning (raster scanning) image acquisition by means of a scanning microscope having an illumination beam path comprising at least one light source with three or more selectively emittable disjoint spectral bands, a detection beam path comprising a microscope objective and a two-dimensionally spatially resolving sensor for recording light from a sample space, a main beam splitter embodied as a spectral N-fold notch filter (with N=3, 4, 5, 6 spectral notches) that optically couples the illumination beam path and the detection beam path to each other (such that illumination light from the light source, in particular the spectral bands, passes to the sample space through the objective and the sample light, in particular fluorescence emissions, passes to the sensor from there through the objective), wherein each notch of the notch filter spectrally corresponds to a respective spectral band from those of the light source, and a secondary color splitter designed as a high or low pass filter with a spectral edge and optically arranged between the main beam splitter and the sensor, each of the locations to be scanned in the sample space is illuminated sequentially with the first spectral band and the second spectral band and also illuminated with the third spectral band during illumination with the first spectral band, wherein the first and second spectral bands are spectrally located on a first spectral side of the spectral edge of the secondary color splitter and the third spectral band is located on a second spectral side that differs from the first side. In this way, three or more fluorescent dyes can be excited in a short time and their fluorescence emission can be recorded in separate images. A spectral band may in particular have the relevant width of a respective individual emission line of a laser. For example, the N-fold notch filter may be designed as in US 2014/0092460 A1.

The selection of the simultaneously illuminating spectral bands and the change of the sequentially illuminating spectral bands can preferably be implemented without mechanical movement, in particular by means of one or more acousto-optic elements, for example by means of an acousto-optic tunable filter (AOTF). In combination with the multiple notch filter of the main color splitter and the spectral division into two by the secondary color splitter, this allows three or more spectral bands to be guided in a very short time to every location to be scanned in the sample space, in particular for recording a corresponding number of fluorescent dyes in separate images.

Particularly preferably, microscopes having four illumination light spectral bands and a quad-notch filter with these spectrally corresponding notches are used as the main beam splitter or microscopes with six or more illumination light spectral bands and interchangeable multiple notch filters with different subgroups of notches, which spectrally correspond to the spectral bands, are used as the main beam splitter, for example two quad-notch filters on a filter wheel or filter slider or a quad-notch filter and a dual-notch filter on a filter wheel or filter slider, preferably with an electric drive in each case.

Preferably, each location to be scanned in the sample space in these microscopes is illuminated sequentially with pairs of spectral bands (first and third spectral bands at the same time, preceded or followed by second and fourth spectral bands at the same time), wherein in each of these pairs one of the spectral bands is located on the first spectral side and the other spectral band is located on the second spectral side of the spectral edge of the secondary color splitter. In this way, the color split can be optimally used to record an even number of fluorescent dyes as quickly as possible.

The pairs (in particular the one consisting of the first and the third spectral band) can be immediately successively radiated either at each of the locations to be scanned in the sample space during each (almost) constant position of the beam deflection unit or else in alternation after a complete scanning operation over all the locations to be scanned in the sample space.

Such methods can advantageously be used with the microscope according to the invention with tilted detection optical unit and tilted beam deflection unit in order to record 2n+2 (n=1, 2, . . . ) spectrally different images of the sample space, in particular of n different fluorescent dyes, in a very short time. However, such a sequential-simultaneous method can also be used with conventional scanning microscopes. The wavelength pairs must be switched as quickly as possible. For example, this is achieved using acousto-optic filters (AOTF) or micro-mirrors (DMD), in particular with microelectromechanical systems (MEMS). Such methods require one or more light sources with an overall corresponding number of selectively emittable spectral bands. In an alternative, a broadband or white light source can be used. In the event of only one light source, it is expedient to use an AOTF which steers a plurality of spectral bands to the microscope objective in a programmable manner at the same time. However, a respective AOTF can be provided for each light source or for groups of light sources.

Particularly advantageous embodiments are those in which a difference between a number of reflections of the first component up to the sensor and a number of reflections of the second component up to the sensor—including reflections off the secondary beam splitter itself—is an odd number, wherein the optical axes of the two components pass through the detection optical unit preferably in the same plane and at the same distance from and at the same angle to the optical axis of the detection optical unit, albeit on opposite sides of this axis. On account of the odd number of reflections, the beam of the first component is precisely mirror-inverted to the beam of the second component. Since the detection optical unit is preferably rotationally symmetric, both components are subject to the same aberrations, and so their images on the sensor have comparable properties. The aberrations of both components can therefore be largely compensated by a tilt of the beam deflection unit about an axis perpendicular to its scanning axis of rotation, as described above. Then, one of the images is mirrored vertically (about the y-axis) and must be reversed accordingly before it can be processed further.

In a possible more complex embodiment, the detection beam path comprises a second detection optical unit and the first component passes to the sensor through the first detection optical unit away from the reflector, and the second component passes to the same sensor or to a separate sensor through the second detection optical unit via the reflector. The optical axes of each component can coincide here with the respective optical axis of one of the two detection optical units, whereby fewer aberrations arise. In particular, it is thereby possible to manage without tilting of the beam deflection unit and the detection optical units.

Advantageously, the beam deflection unit can comprise MEMS micromirrors and in particular deflect the illumination light only in one-dimensionally adjustable fashion. This enables a compact structure and high deflection frequencies. A beam deflection unit comprising two-dimensionally adjustable MEMS micromirrors alternatively has the advantage that scanning along the longitudinal direction of the illumination line is possible in order to either expand or homogenize the illumination of the sample space or minimize coherent effects. To this end, scanning along the longitudinal direction of the line in the sample space is faster than scanning across the longitudinal direction of the line. Resonant quasi-static MEMS scanners are particularly advantageous to this end. In an alternative, a MEMS scanner quasi-static in both axes can be used to minimize only the coherent interference effects in the illumination. Then, it might be advantageous to control the axis for scanning along the longitudinal direction of the illumination line with white noise of predetermined amplitude. In an alternative, the beam deflection unit can comprise one or more galvanometer scanners. The longitudinal direction of the illumination line extends in the direction of its longest extent.

Particularly preferred embodiments are those in which the microscope comprises a stand on which the microscope objective is arranged, in particular within an objective turret, wherein the stand comprises a first port, in the region of which the tube lens and the intermediate image are arranged, and at least one further port having a further tube lens and a further intermediate image, wherein the sample light can be guided simultaneously or sequentially to both ports by means of at least one beam splitter, in particular a repeatedly removable beam splitter, or by means of a mirror, wherein the main beam splitter, the detection optical unit, the sensor, the beam deflection unit and a scanning unit are arranged within a module optically and mechanically detachably connected to one of the ports. This allows the provision of a flexible microscope system with few aberrations and a short acquisition time.

### BRIEF DESCRIPTION OF THR DRAWINGS

The invention is explained in more detail below on the basis of exemplary embodiments.

In the drawings:

FIG. 1 shows a microscope,

FIGS. 2A and 2B shows beam paths of a microscope and

FIG. 3 shows geometric extents of the images of the detection focus on the sensor.

In all of the drawings, matching parts bear the same reference signs.

### DETAILED DESCRIPTION OF THE INVENTION WITH REFERENCE TO THE DRAWINGS

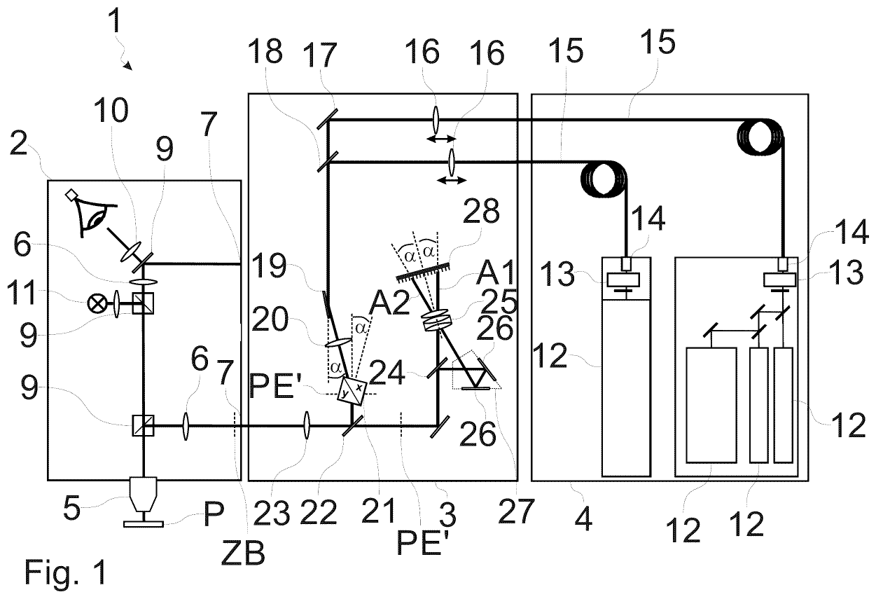

FIG. 1 shows a schematic illustration of a microscope 1. It consists of a stand 2, a scan module 3 and a laser module 4. The stand 2 has a microscope objective 5 with tube lenses 6, which each create an intermediate image ZB in the region of two ports 7. The stand also comprises a beam splitter 9 capable of being pivoted-in, for example neutral-intensity splitter or color splitter, in order to guide light proportionally in selectively configurable fashion to the ports and/or to the eyepiece 10 and/or to guide light from a lamp 11 to the microscope objective 5 and from there into the sample space P.

Purely by way of example, the laser module 4 comprises four lasers 12 with different emission wavelengths, the respective intensity of which can be adjusted by means of a respective AOTF 13. In an alternative (not shown), one or more of the lasers can be modulated directly. Their illumination light is input coupled into optical fibers 15 via coupling optical units 14 and guided to the scan module 3, where it is collimated by means of longitudinally displaceable collimators 16, for example. The collimators 16 can serve to compensate for chromatic longitudinal aberrations and/or to focus the illumination light at different depths in the sample space P. In an alternative (not shown), the different emission wavelengths can for example already be combined in the laser module such that only a single optical fiber 15 is required, and it is possible to manage without collimators 16. Via a mirror 17 and a beam combiner 18, the illumination light combined thus passes to a deflection mirror 19 which deflects the illumination light in such a way that, after said illumination light has passed a cylindrical lens 20, it is incident at an angle of incidence a on the beam deflection unit 21 which in turn is tilted by an identical angle α about an axis perpendicular to its scanning axis of rotation vis-à-vis an optical axis OA of the microscope objective 5, which is deflected by means of a main beam splitter 22. From the main beam splitter 22, the illumination light passes via the scan lens 23, the intermediate image ZB and one of the tube lenses 6 to the microscope objective 5 and from there into the sample space P. Since the cylindrical lens focuses the illumination light in one dimension into the plane conjugate with the pupil of the microscope objective 5 and located on the beam deflection unit 21, a basically linear illumination focus volume arises in the sample space. On account of the tilt of the beam deflection unit 21, the linear illumination focus volume is increasingly oblique in the sample space P as distance from the optical axis of the microscope objective 5 increases.

Sample light, in particular also fluorescence excited by the illumination light in the sample, passes in the opposite way via the intermediate image ZB to the main beam splitter 22. The component of the illumination light reflected in the sample and on the way there is reflected back to the beam deflection unit by the main beam splitter 22, which for example is designed as a dichroic notch filter. Fluorescence contained in the sample light is transmitted, in particular due to the Stokes shift, through the main beam splitter 22 to a secondary beam splitter 24, which for example is designed as a dichroic low pass filter. The scan lens 23 is designed such that a plane conjugate to the pupil of the microscope objective 5 is located firstly on the beam deflection unit 21 and secondly in the region of the secondary beam splitter 24. The secondary beam splitter 24 divides the sample light remaining at this point (typically fluorescence emission) into two components by way of its spectral low pass effect. The first component A1 is passed directly to a detection optical unit 25 by transmission. The second component A2 is initially reflected off two inner surfaces 26 of a prism 27, and so the second component experiences an odd number of reflections before it also enters the detection optical unit 25. However, vis-à-vis the optical axis OA of the microscope objective 5, the detection optical unit 25 is tilted within a plane spanned by the pixel lines of the sensor and the optical axis OA of the microscope objective 5 by for example the same angle a as the beam deflection unit 21, whereby the two components A1, A2 separated at the secondary beam splitter 24 are incident into the detection optical unit 25 at equal angles of opposite sign and experience symmetrically opposite aberrations in this way. These, however, compensate for precisely an aberration impressed on the illumination light by the tilt of the beam deflection unit 21. In alternative embodiments (not shown), the tilt angles of detection optical unit 25 and beam deflection unit 21 may differ from each other in order to compensate for another aberration. In all cases, however, the two tilt angles differ from zero. The two components pass as disjoint, largely error-corrected images (a respective “component image”) to the sensor 28, which has a “rolling shutter” as a line-confocal slit-type stop, with which the movement of the beam deflection unit 21 is synchronized, for example by starting the scanner movement on the basis of a signal emitted by the sensor 28 operated in a light sheet readout mode and indicating the beginning of a new image on the sensor 28. By means of the compensation, the linear detection focus volume in the sample space P at a positionally dependent angle is imaged parallel to the pixel line and thus with minimized distortion on the respective active, straight line of the “rolling shutter”. A control unit (not depicted here) reads the sensor, for example after acquiring a complete sensor frame, assigns its data to two respective digital images and reflects the data of the digital image corresponding to the second sample light component vertically so that both digital images have the same perspective.

The tilt angle α of the detection optical unit 25 and beam deflection unit 21 corresponds to α=arctan(Δx/f), where Δx is the offset length of the images on the sensor (projected relative to the optical axis of the detection optical unit 25) and f is the sensor-side focal length of the detection optical unit 25.

The scan module can be designed in a particularly compact and efficient way because (in addition to the intermediate image planes ZB at the ports of the stand 2) an image plane is arranged only on the sensor 28, and only exactly one pupil plane PE′ conjugate to the microscope objective 5 is arranged in each branch of the detection beam path downstream of the main beam splitter 22 in the detection direction.

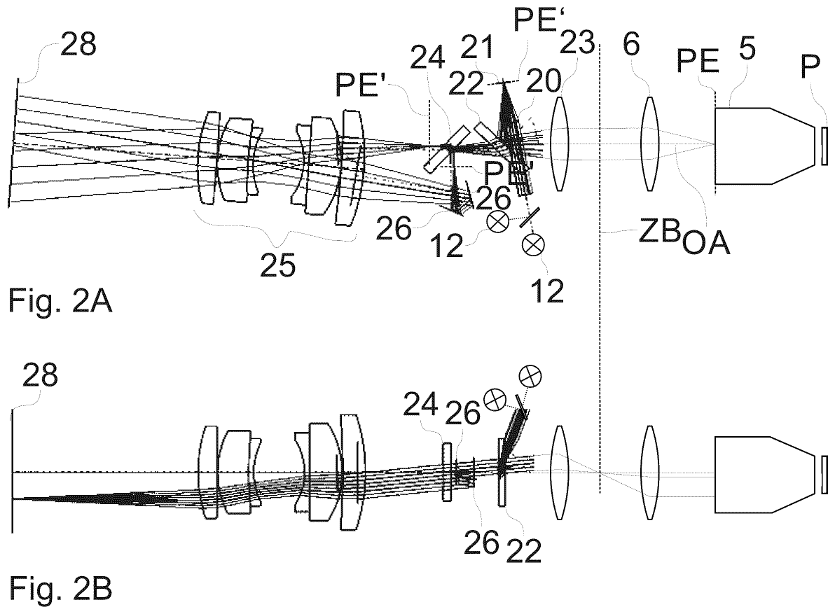

FIG. 2 schematically depicts the beam paths of a microscope 1. Partial FIG. 2A shows them in a plan view, partial FIG. 2B in a side view. The pupil plane PE of the microscope objective 5, the pupil planes PE′ conjugate thereto and the intermediate image plane ZB are easily recognizable. In this respect, the arrangement shown corresponds to that in FIG. 1. Here, too, the detection beam path comprises only exactly one intermediate image ZB between the microscope objective 5 and the sensor 28 and only exactly one conjugate pupil plane PE′ in each branch between the tube lens 6 and the sensor 28. In alternative embodiments (not shown here), further conjugate pupil planes and/or intermediate image planes might be present by means of an additional relay optical unit.

In deviation from FIG. 1, the illumination light is spatially guided around the main beam splitter 22 to the beam deflection unit 21—the lasers 12 are arranged above the optical axis OA of the microscope objective 5, as evident from the lateral view. To this end, the beam deflection unit 21 is additionally tilted around its scanning axis of rotation. Via a deflection mirror (not depicted here), for example the one that deflects the illumination light in such a way that, after passing the cylindrical lens 20, it is incident on the beam deflection unit 21 at an angle of incidence a, the illumination light initially passes obliquely to the plane spanned by the optical axis OA of the microscope objective 5 and the longitudinal direction x of the sensor lines, where it is incident on the beam deflection unit 21. The beam deflection unit 21 is twisted precisely such that the reflection of the illumination light to the microscope objective 5 is implemented within the said plane.

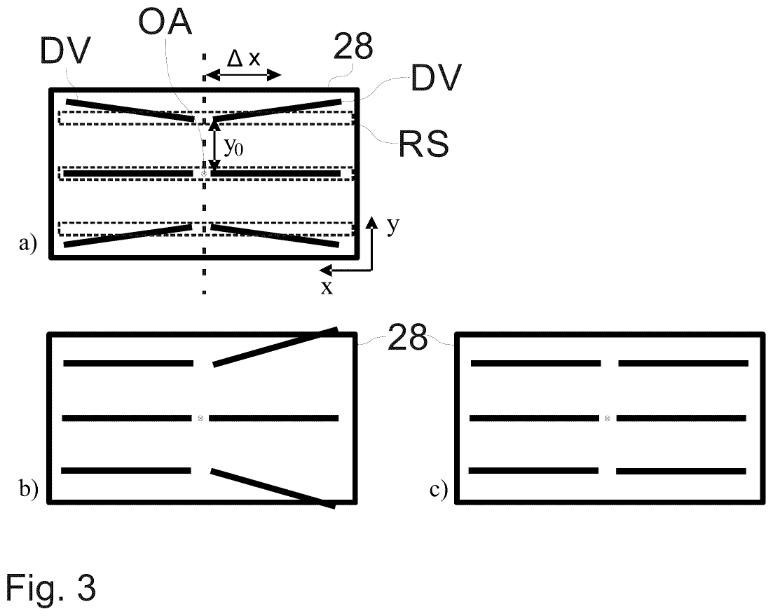

FIG. 3 schematically shows the detection focus volume, imaged on the sensor in two component images by beam splitting, at different times of a scanning procedure in three different, exemplary configurations to visually illustrate the effect of the invention.

Partial figure a) shows the result of a fictitious configuration in which the detection optical unit but not the beam deflection unit is tilted relative to the optical axis of the microscope objective 5. The scanning illumination of the sample space P is conventionally centered around the optical axis of the microscope objective here. On account of the tilt of the detection optical unit, the detection focus volume DV increases in inclination toward both vertical image edges, i.e. in the y-direction, resulting in distortion. The current position of the electronic stop of a “rolling shutter” RS is also plotted. It is clearly evident that due to the inclination, only small parts of the detection focus volume can be detected by the active region of the sensor. It is true that the entire detection focus volume could be captured by increasing the width of the RS electronic slit-type stop. However, in order to achieve greater suppression of out-of-focus light, it would be necessary to also use narrower RS electronic slit-type stops, in particular with a width of only one pixel line.

Partial figure b) is the result of a configuration in which both the detection optical unit and the beam deflection unit are tilted, wherein, however, the right component image is exposed to an even number of reflections after the secondary beam division, while the left component image is not reflected at all after the secondary beam division. This does not compensate for the inclination and the resulting distortions but even tends to increase them.

Finally, partial figure c) shows the result of a configuration in which both the detection optical unit and the beam deflection unit are tilted and the right component image is exposed to an odd number of reflections after the secondary beam division, while the left component image is once again not reflected at all after the secondary beam division. This largely compensates for the inclination and thus the distortions previously present.

### LIST OF REFERENCE SIGNS

1 Microscope
2 Stand
3 Scan module
4 Laser module
5 Microscope objective
6 Tube lenses
7 Port
8
9 Beam splitter
10 Eyepiece
11 Lamp
12 Laser
13 AOTF
14 Input coupling optical unit
15 Optical fiber
16 Collimator
17 Mirror
18 Beam combiner
19 Deflection mirror
20 Cylindrical lens
21 Beam deflection unit
22 Main beam splitter
23 Scan lens
24 Secondary beam splitter
25 Detection optical unit
26 Internal prism surface
27 Prism
28 Sensor 8
P Sample space
OA Optical axis
ZB Intermediate image
PE Pupil plane
PE′ Conjugate pupil plane
DV Detection focus volume
RS Rolling shutter
α Tilt angle
A1 First component
A2 Second component

1. Microscope comprising an illumination beam path, a detection beam path and a main beam splitter, wherein the detection beam path has a sample space, a microscope objective, a tube lens, an intermediate image created by the tube lens and a two-dimensionally spatially resolving optoelectronic sensor having a detection optical unit for imaging the intermediate image on the sensor and wherein the illumination beam path has a light source and an adjustable beam deflection unit for moving the illumination light through the sample space, wherein the illumination beam path and the detection beam path are optically coupled to form a common beam path by means of the main beam splitter such that illumination light from the light source passes into the sample space through the microscope objective via the main beam splitter and sample light from the sample space passes through the microscope objective via the main beam splitter to the sensor, wherein the beam deflection unit is optically arranged between the light source and the main beam splitter such that the sample light away from the beam deflection unit passes to the sensor, and in that both the illumination light traveling to the microscope objective and the sample light traveling to the sensor pass through the same intermediate image created by the tube lens.

2. Microscope according to claim 1, wherein the common beam path comprises an optical unit located optically between the intermediate image and the main beam splitter and serving to create a pupil plane conjugate to a pupil of the microscope objective, the pupil plane being located on or near the beam deflection unit, wherein the formation of this conjugate pupil plane by reflection off the main beam splitter, occurs with transmission through the conjugate pupil plane into the detection beam path in the vicinity of a secondary beam splitter.

3. Microscope according to claim 1, wherein the detection optical unit is arranged in such a way that its optical axis is tilted by a first non-zero angle relative to an optical axis of the microscope objective, and so that an image of the sample space on the sensor is offset away from the optical axis by an offset length, and the beam deflection unit is tilted by a second non-zero angle, of almost the same size, about an axis perpendicular to its scanning axis of rotation such that a first aberration resulting from the tilt of the detection optical unit and a second aberration resulting from the tilt of the beam deflection unit compensate each other at least in part, with a vertical arrangement of the optical axis of the detection optical unit with respect to a surface of the sensor.

4. Microscope according to claim 3, wherein the tilt angle corresponds to arctan(Δx/f), where Δx is the offset length on the sensor and f is the (sensor-side) focal length of the detection optical unit.

5. Microscope according to claim 1, wherein the illumination beam path comprises a beam shaper for creating a linear distribution of the illumination light and wherein the sensor has a line-shaped electronic stop arranged confocally to the intermediate image, in the form of a rolling shutter with capability of synchronizing an adjustment of the beam deflection unit and a dynamic position of the stop, by way of a control unit electrically connected to the sensor and the beam deflection unit.

6. Microscope according to claim 1, wherein the detection beam path between the main beam splitter and the detection optical unit comprises a secondary beam splitter and at least one reflector, wherein the secondary beam splitter divides the sample light into two components and guides the latter to disjoint regions of the sensor or to a respective sensor such that two disjoint images of the sample space arise with identical offset lengths for both images, wherein only one of the components passes to the relevant sensor via the reflector with the embodiment of the secondary beam splitter to split colors in the form of a dichroic splitter or a neutral-intensity splitter.

7. Microscope according to claim 6, wherein the illumination beam path comprises a second light source having a different emission wavelength to the first light source and wherein the secondary beam splitter is a color splitter, said color splitter being either a high pass filter or a low pass filter.

8. Microscope according to claim 6, wherein a difference between a number of reflections of the first component up to the sensor and a number of reflections of the second component up to the sensor is an odd number.

9. Microscope according to claim, wherein the detection beam path comprises a second detection optical unit and the first component passes to the sensor through the first detection optical unit away from the reflector, and the second component passes to the sensor through the second detection optical unit via the reflector.

10. Microscope according to claim 1, wherein the beam deflection unit comprises MEMS micromirrors and in particular can deflect the illumination light only in one-dimensionally adjustable fashion.

11. Microscope according to claim 1, wherein the beam deflection unit is rotated about its scanning axis of rotation in such a way that the illumination light passes to the beam deflection unit in a plane that differs from a plane spanned by the optical axis of the microscope objective and a longitudinal direction of a pixel line of the sensor.

12. Microscope according to claim 1, wherein the microscope comprises a stand on which the microscope objective is arranged, in particular within an objective turret, wherein the stand comprises a first port, in the region of which the tube lens and the intermediate image are arranged, and at least one further port having a further tube lens and a further intermediate image, wherein the sample light can be guided simultaneously or sequentially to both ports by means of at least one beam splitter, in particular a repeatedly removable beam splitter, or by means of a mirror, wherein the main beam splitter, the detection optical unit, the sensor, the beam deflection unit and a scanning unit are arranged within a module optically and mechanically detachably connected to one of the ports.

13. Microscope according to claim 1, wherein the light source comprises three or more selectively emittable disjoint spectral bands, and the main beam splitter is embodied as a spectral N-fold notch filter (N=3, 4, 5, 6), and each notch of the notch filter spectrally corresponds to a respective spectral band from those of the light source, in particular equipped with a control unit configured to carry out a method according to any of the following claims.

14. Method for scanning image acquisition by means of a scanning microscope having an illumination beam path having at least one light source with three or more selectively emittable disjoint spectral bands, a detection beam path having a microscope objective and a two-dimensionally spatially resolving sensor for recording light from a sample space, a main beam splitter embodied as a spectral N-fold notch filter (N=3, 4, 5, 6) that optically couples the illumination beam path and the detection beam path to each other, wherein each notch of the notch filter spectrally corresponds to a respective spectral band from those of the light source, and a secondary color splitter designed as a high or low pass filter with a spectral edge and optically arranged between the main beam splitter and the sensor, wherein said method comprises scanning each of the locations to be scanned in the sample space is illuminated sequentially with the first spectral band and the second spectral band, and illuminating with the third spectral band during illumination with the first spectral band, wherein the first and second spectral bands are spectrally located on a first spectral side of the spectral edge of the secondary color splitter and the third spectral band is located on a second spectral side that differs from the first side.

15. Method according to claim 14, wherein the selection of the simultaneously illuminating spectral bands and the change of the sequentially illuminating spectral bands are implemented without mechanical movement, by means of one or more acousto-optic elements.

16. Method according to claim 14 further comprising using microscopes having four illumination light spectral bands and a quad-notch filter with these spectrally corresponding notches as the main beam splitter or using microscopes with six or more illumination light spectral bands and interchangeable multiple notch filters with different subgroups of notches, which spectrally correspond to the spectral bands, as the main beam splitter, having two quad-notch filters on a filter wheel or filter slider or a quad-notch filter and a dual-notch filter on a filter wheel or filter slider with an electric drive in each case.

17. Method according to claim 14, further comprising illuminating each location to be scanned in the sample space sequentially with pairs of spectral bands, wherein in each of these pairs one of the spectral bands is located on the first spectral side and the other spectral band is located on the second spectral side of the spectral edge of the secondary color splitter with the pairs being immediately successively radiated at each of the locations to be scanned in the sample space during each constant position of the beam deflection unit.

18. Method according to claim 14. comprising using a microscope according to claim 1.
